(19) United States
(12) Patent Application Publication
(10) Pub. No.: US 2024/0114179 A1
(43) Pub. Date: Apr. 4, 2024

(54) SYSTEMS AND METHODS FOR SELECTIVELY STORING MEDIA CONTENT ON PORTABLE PLAYBACK DEVICES

(71) Applicant: Sonos, Inc., Santa Barbara, CA (US)

(72) Inventors: Ryan Richard Myers, Santa Barbara, CA (US); Konstantin Vovk, Seattle, WA (US); Sein Woo, Somerville, MA (US); John G. Tolomei, Renton, WA (US)

(21) Appl. No.: 18/473,761

(22) Filed: Sep. 25, 2023

Related U.S. Application Data
(60) Provisional application No. 63/377,915, filed on Sep. 30, 2022.

(51) Int. Cl. H04N 21/222; H04N 21/43

(52) U.S. Cl. CPC H04N 21/2223; H04N 21/4307

(57) ABSTRACT

A media playback system for streaming content and/or playing stored media content is disclosed. The media playback system can configure the first playback device to stream content items received via a network connection without storing the streamed content in a first content store. After receiving an indication to store content, the media playback system identifies one or more content items to download for storage in the first content store. After the one or more content items are selected, the content items can be retrieved and stored on the playback device. Furthermore, the media playback system can configure a playback device to play content items from the first content store of the first playback device. In this manner, the first playback device need not be connected to the Internet or to a controller device to play content. Moreover, the playback device can switch between playing stored content and streaming content.

### CROSS-REFERENCE TO RELATED APPLICATION

This application claims the benefit of priority to U.S. Patent Application No. 63/377,915, filed Sep. 30, 2022, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows a front view of a control device.

FIG. 6 shows a message flow diagram of a media playback system.

FIG. 7 illustrates an example method for playing content on one or more playback devices.

FIG. 8 illustrates an example method for selecting content items to download onto one or more playback devices.

FIG. 9 illustrates an example method for downloading and storing content items on a playback device.

FIG. 10 illustrates an example method for coordinated playback of a content item among a group of playback devices by a playback group coordinator.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

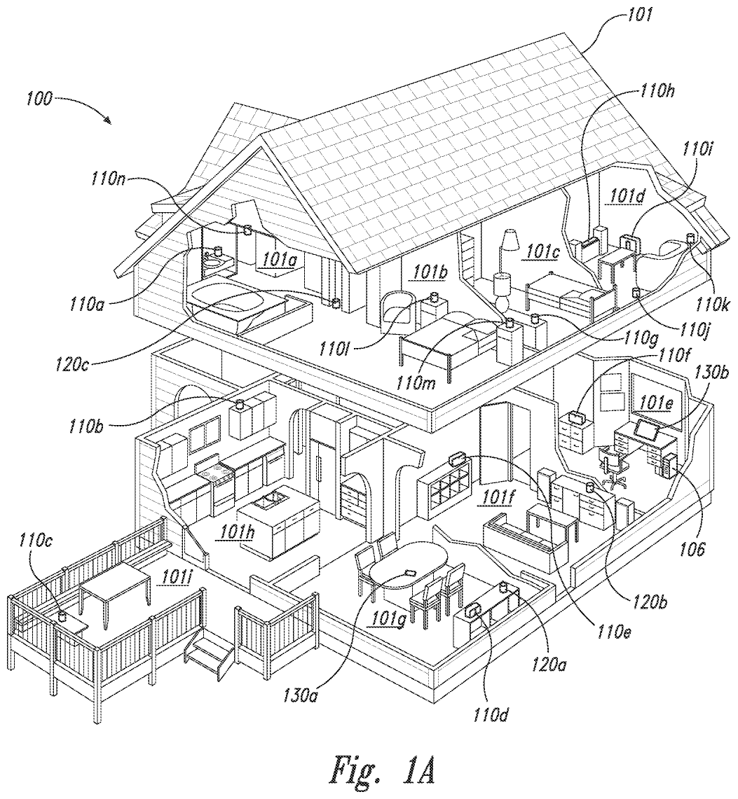

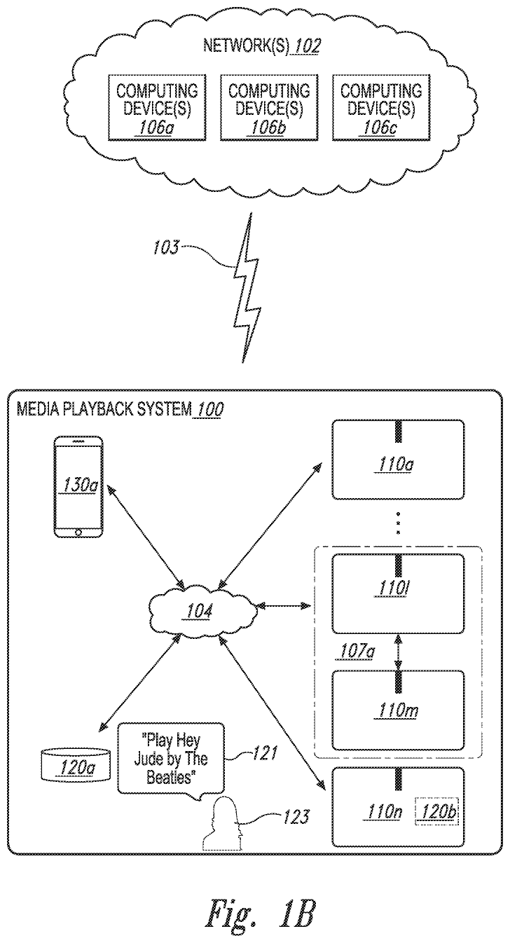

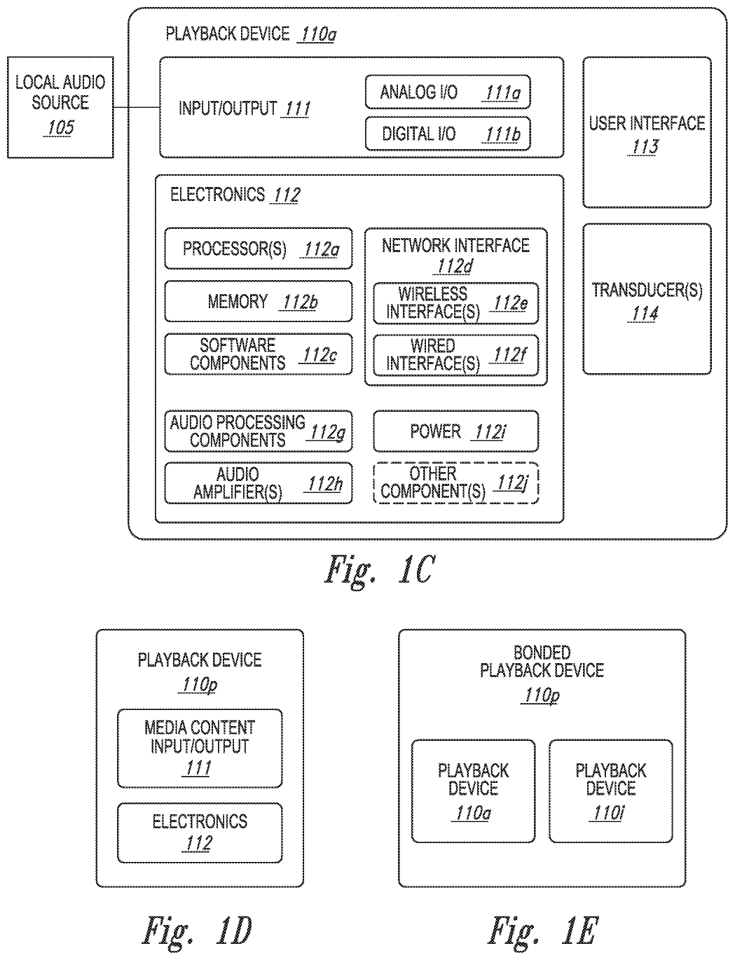

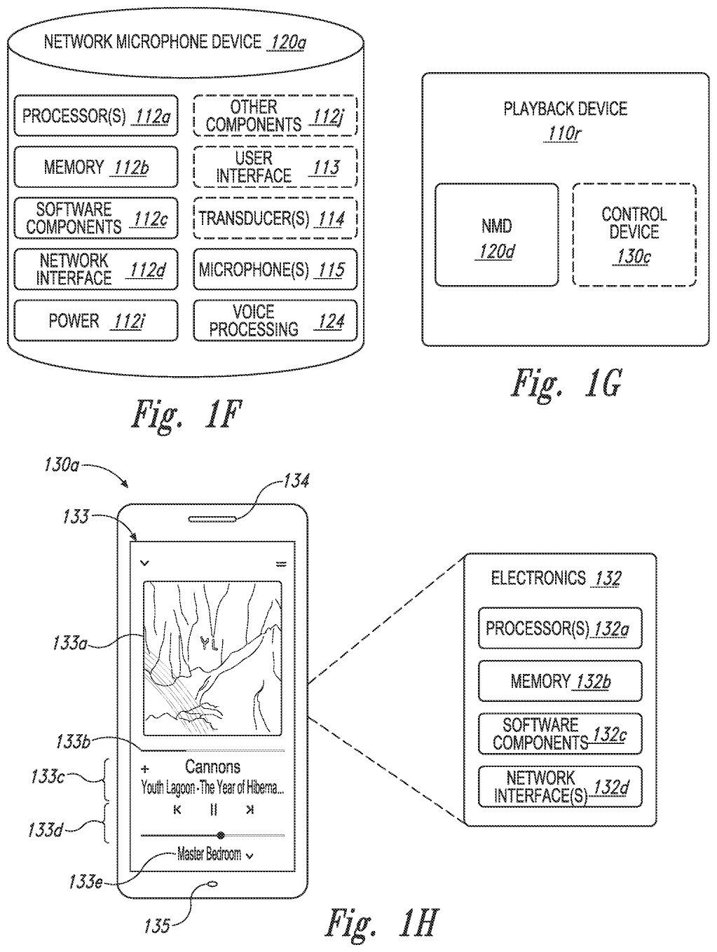

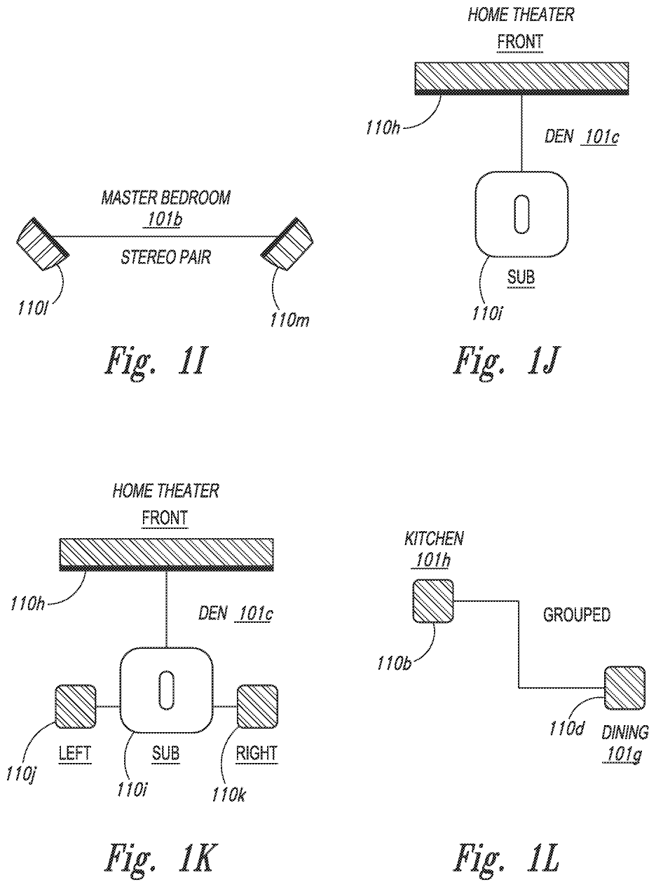

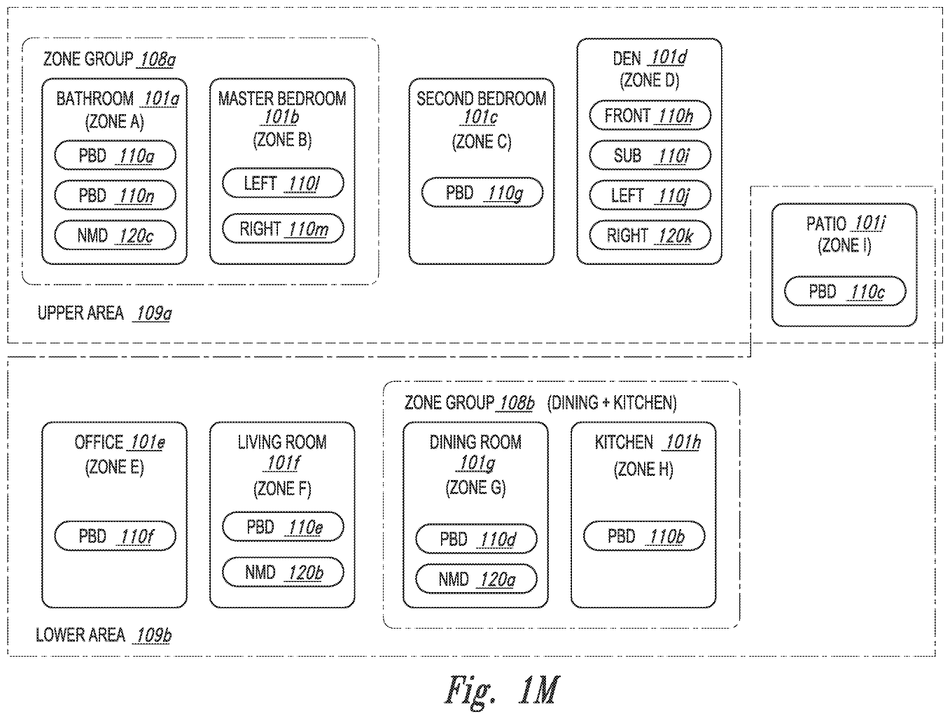

Conventional media playback systems often include one or more playback devices, such as playback devices 110 (FIG. 1A), for playing media. Playback devices that can be configured to stream media from another device or source have access to potentially millions of media assets or media content items from which to choose from via one or more media providers, including digital streaming services such as SPOTIFY®, APPLE MUSIC®, AMAZON MUSIC®, PRIME VIDEO®, and so on. Furthermore, one or more users may each have their own storage device, such as a mobile phone, network attached storage device, etc., that can provide or stream media to a playback device for playback (and, in some cases, control the playback). The ability to play content items from other devices and/or sources allow these streaming playback devices to playback media content without being limited by the storage capacity of the playback devices themselves. Thus, these streaming playback devices offer great portability and access to a wealth of entertainment provided they have a suitable connection to a media provider (e.g., an Internet connection to a digital streaming service, etc.), another device (e.g., a WiFi or BLUETOOTH® connection to a controller device, etc.), and so on. However, these connections may not always be present. For example, a user may wish to take a playback device to a location without a decent connection to the Internet, such as to the beach, on a camping trip, their backyard, etc. As another example, if the user is streaming music from their phone to the playback device and the user steps away from the playback device or receives a phone call, a BLUETOOTH connection between the user's phone and the playback device may be lost or disrupted, thereby disturbing those enjoying the streaming music. As another example, if a user jogs or works out while wearing a pair of headphones, the user is unlikely to want to interrupt their activity to connect to another WiFi network, retrieve or move a BLUETOOTH connected controller device, etc. to hear the music they curated for the activity. Moreover, a playback device may be used in an environment in which no particular user is responsible for maintaining wireless connectivity, such as a small office or waiting room. In these environments, when a device loses network connectivity the device may simply sit idle because nobody is available to address the issue or even aware there is an issue. Accordingly, downloading and playing content from one of the devices would improve their utility to their intended audience.

In some cases, playback devices may have sufficient local memory storage capacity to store content items for playback without a network connection. As such, a user may take a playback device, which is otherwise configured to stream media content via their home WiFi, outside of their home WiFi range, and without connecting to the playback deice via BLUETOOTH, press, for example, a physical play button on the playback device to begin enjoying stored content. This both improves “time to music” experience with the playback device and allows playback without concern that a controller device or media provider is out of communication range or otherwise unable to provide content. Accordingly, it would be beneficial for the media playback system to store media on playback devices to facilitate enjoyment of media content even when there is a lack of connectivity. Moreover, it would be beneficial for the media playback system to provide an improved user interface for determining which content items to store on one or more playback devices and when to store those content items, so that content items are available when the user is expecting them to be available.

The disclosed playback devices, media playback systems, and/or methods can improve upon the media playback experience by selectively storing content items on playback devices and providing an improved user interface for selecting which content items are stored on playback devices and when those content items are stored on playback devices. Moreover, because a playback device need not access an external source to playback downloaded content items, communication systems of the playback device (e.g., WiFi, BLUETOOTH, etc.) can be disabled during local playback, thereby reducing energy consumption and improving upon battery performance and battery lifetime. Moreover, the playback devices can take advantage of playback device group dynamics to provide an enhanced playback environment even when the playback devices have lost connectivity to other media providers or devices. For example, two or more playback devices can coordinate playback of one or more content items (via one or more enabled communication systems) by sending content items to each other for streaming and/or for storage. In this manner, the media playback system can effectively expand the amount of offline storage available to each of the playback devices. For example, if two playback devices are being taken on a camping trip, the storage capacity of each playback device can be used for offline storage and the playback devices can transmit or stream content items to each other during playback. Thus, offline coordinated playback is not limited by the playback device with the least amount of storage capacity. By enabling local storage of content items on streaming playback devices, the media playback system's utility to one or more users is improved as compared to conventional approaches.

In some embodiments, the media playback system comprises a first playback device having a first content store (e.g., a flash memory, resistive random-access memory, etc.). Initially, the media playback system configures the first playback device to stream content items received via a network connection without storing the streamed content in the first content store. For example, the media playback system can configure the first playback device to stream content from a digital streaming service. After receiving an indication to store content, the media playback system identifies one or more content items to download onto the first playback device for storage in the first content store. The indication to store content may be a response to any number of interactions, such as a user pressing a button on the playback device, a user selecting a playlist or songs via a user interface of a mobile application, an automated message or command from the media playback system prompted by a previously scheduled event, an instruction prompted by a detected loss or degradation of a communication signal, and so on. After the one or more content items are selected, the content items can be retrieved and stored on the playback device. In some cases, a user may be warned if the amount of available storage on the playback device will not accommodate a selected content item or group of content items. Alternatively, or in addition, the media playback system may recommend other playback devices with sufficient storage capacity and may further recommend pairing, grouping, or bonding devices to take advantage of their combined storage capacity.

In some embodiments, the content quality (e.g. audio resolution, bit rate, etc.) of the content items that is ultimately stored on the playback device may be lower than the content quality of the content items when they are played back via streaming. Given the use cases of the portable playback device playing back stored content items (e.g. outdoors), the lower content quality may not be discernable by the listeners. On the other hand, storing the content items at lower content quality may allow for a larger number of content items to be stored. Whether a lower content quality version or a higher content quality version of the content items are stored may be determined based on a setting or input by the user.

Furthermore, the media playback system can configure a playback device to play content items from the first content store of the first playback device. In this manner, the first playback device need not be connected to the Internet or to a controller device to play content. Accordingly, one or more aspects of the first playback device can be disabled during local playback, such as WiFi, BLUETOOTH, etc., thereby reducing any load on a battery of the playback device and improving upon battery performance and battery lifetime. For example, if a playback device is playing stored media in an office or other environment where there is nobody to control or otherwise manage playback, the media playback system (or a user) can disable communication systems for the playback device to conserve power resources. As another example, if a playback device is playing stored media at an outdoor party without a WiFi connection or an Internet connection to a media provider, the media playback system (or a user) can disable a WiFi system for the playback device and enable (or keep enabled) a BLUETOOTH system or other communication system for the playback device so that one or more users can send control instructions (e.g., pause, play, skip, etc.) to the playback device via a BLUETOOTH connected controller device. In this manner, the playback device can receive control instructions via a communication channel that uses less power, thereby conserving power resource. Accordingly, a user's experience with respect to controlling playback is similar to situations where content and control instructions are transmitted via a WiFi connection. Additional details regarding this type of communication between a playback device and a controller can be found, for example, in U.S. Application No. 63/243,511, filed on Sep. 13, 2021 and entitled “Techniques for Flexible Control of Playback Devices,” which is incorporated by reference herein in its entirety.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves. For example, one of ordinary skill in the art will recognize that various actions described as being performed by a single actor may be performed by a group of actors and vice versa. For instance, functions described as being performed by a playback device may alternatively or additionally be performed by a controller device and/or a remote computing device e.g. the cloud, in communication with the playback device. Likewise, functions described as being performed by a controller device may alternatively or additionally be performed by the playback device. Other examples are also possible and contemplated.

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WiFi networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more of earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a projector, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

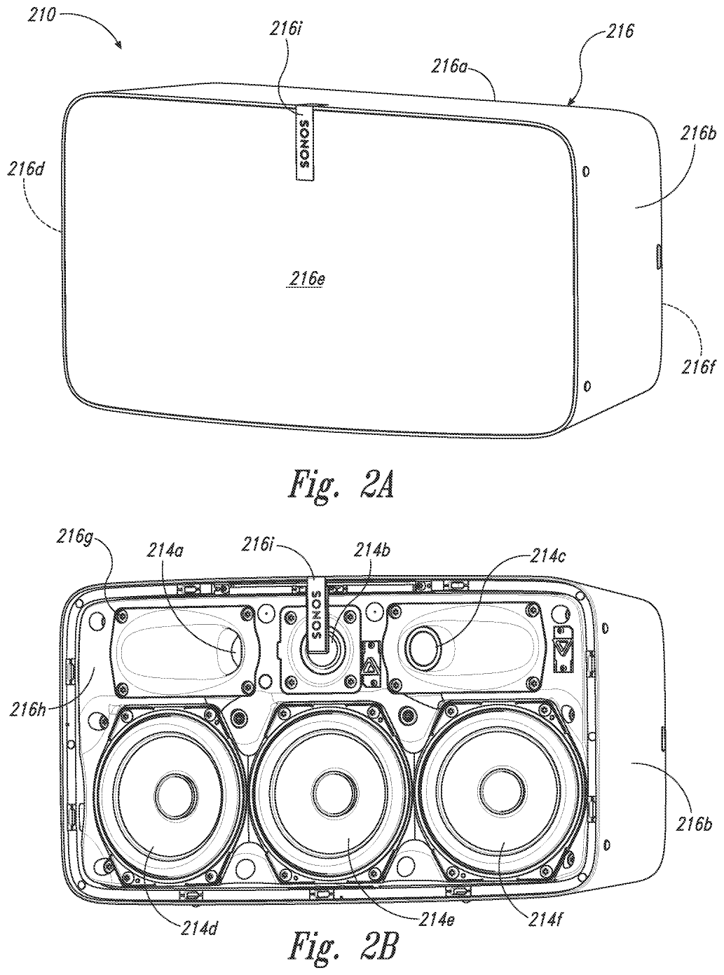

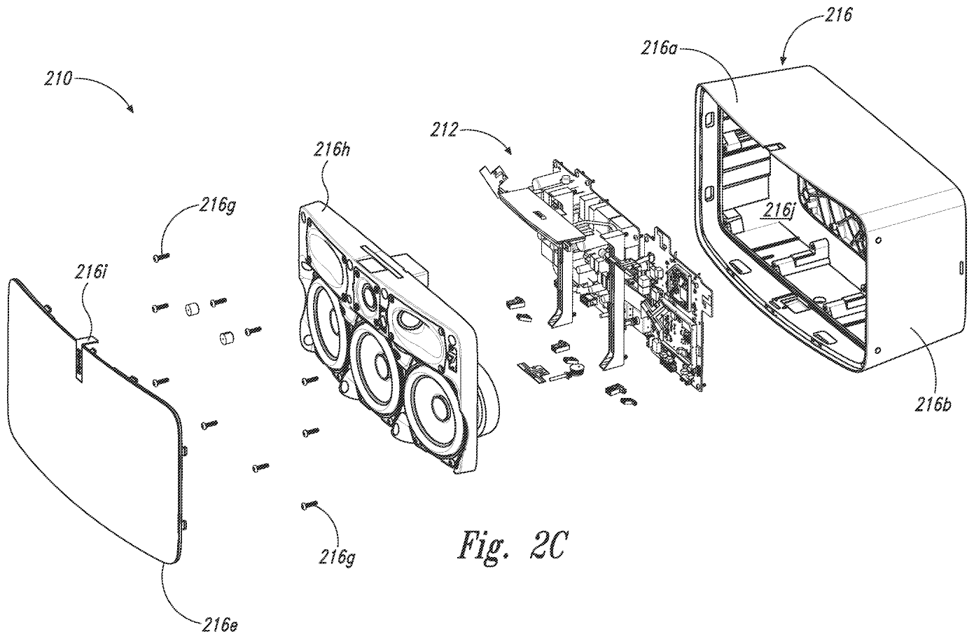

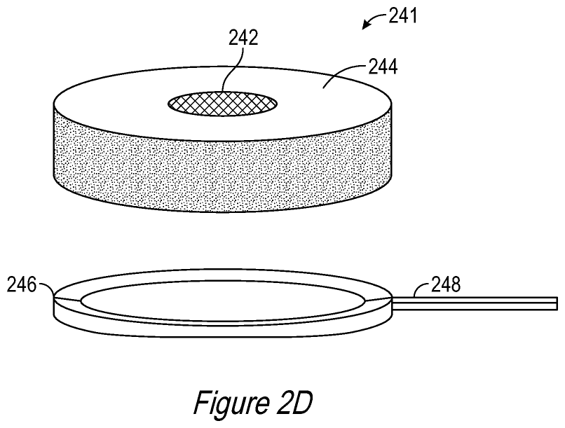

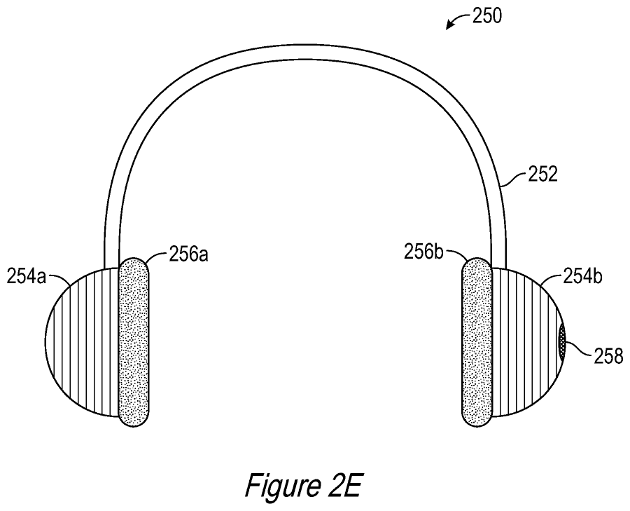

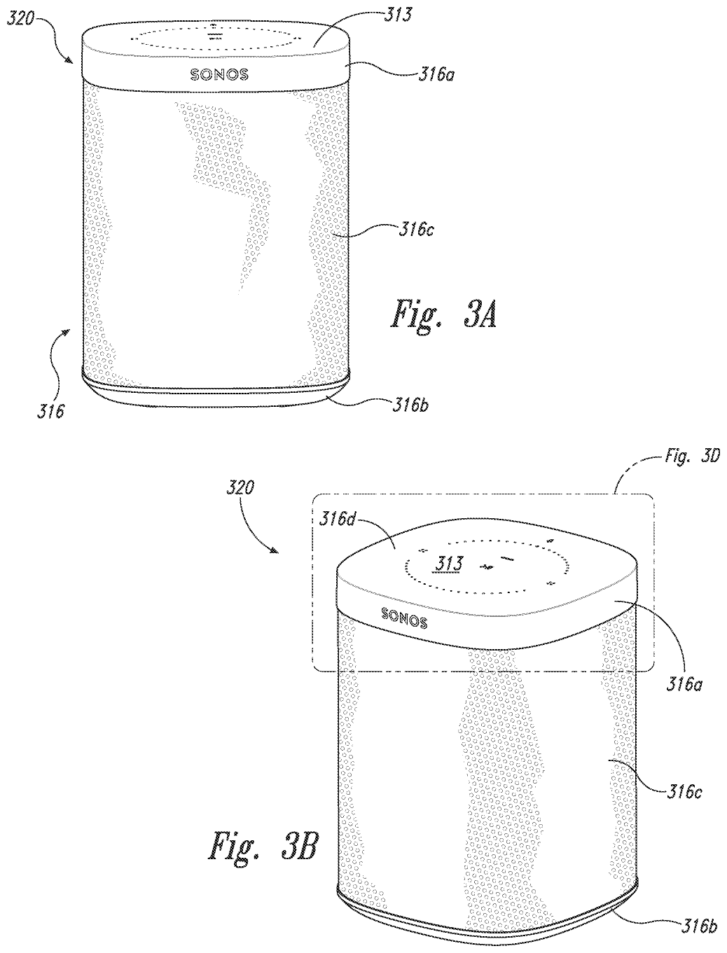

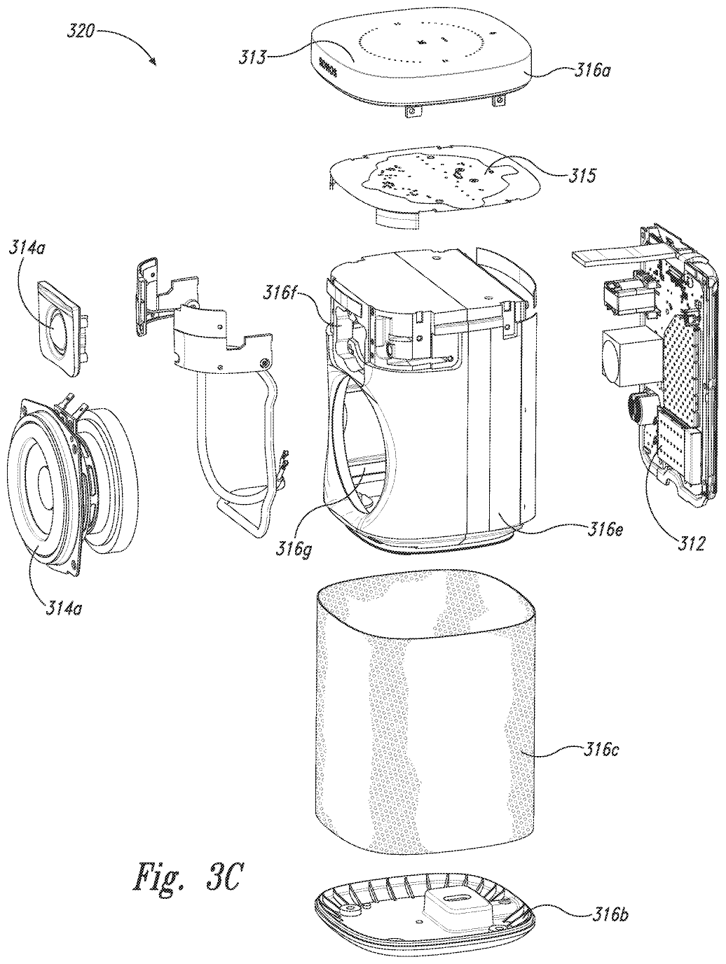

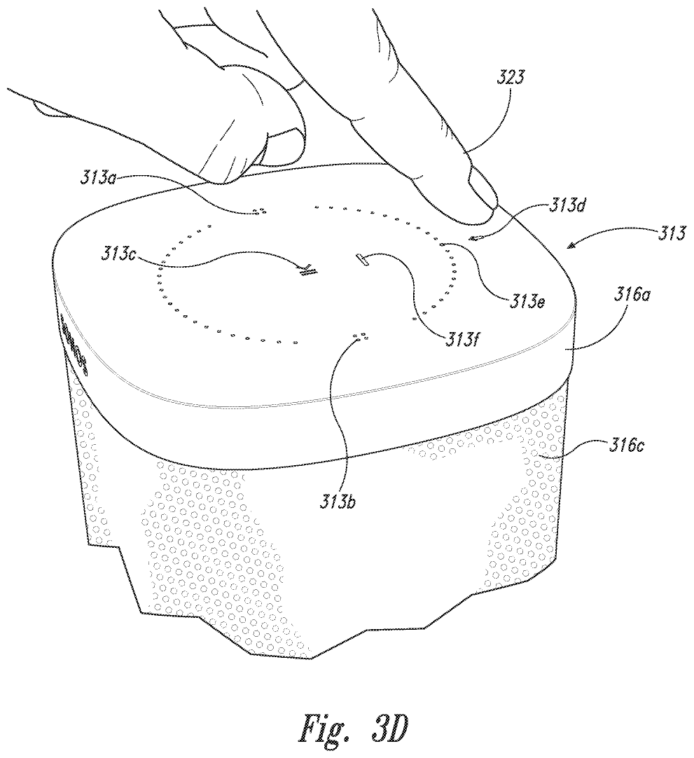

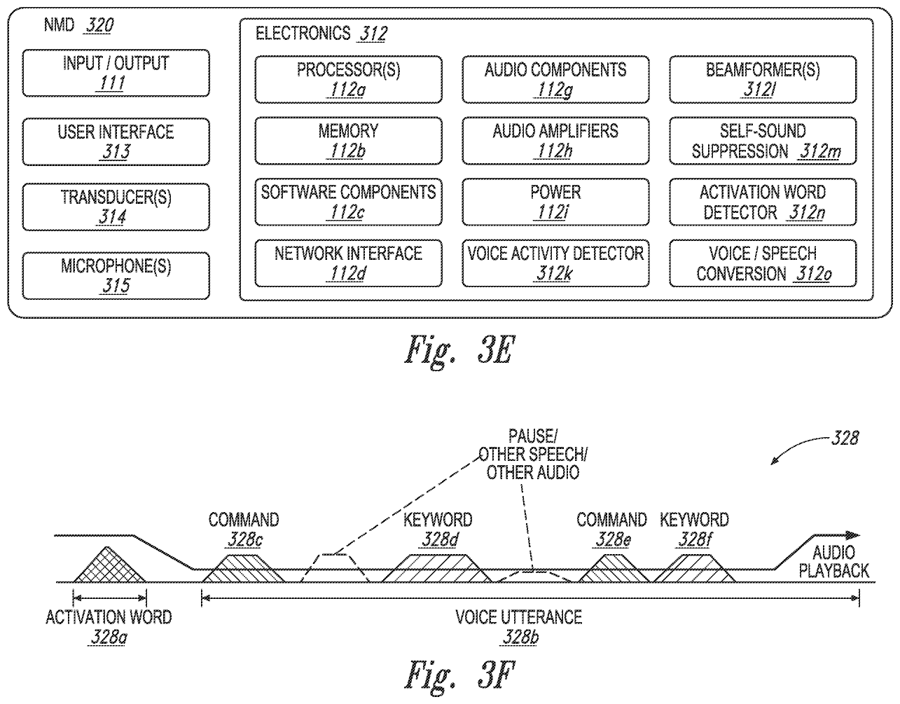

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

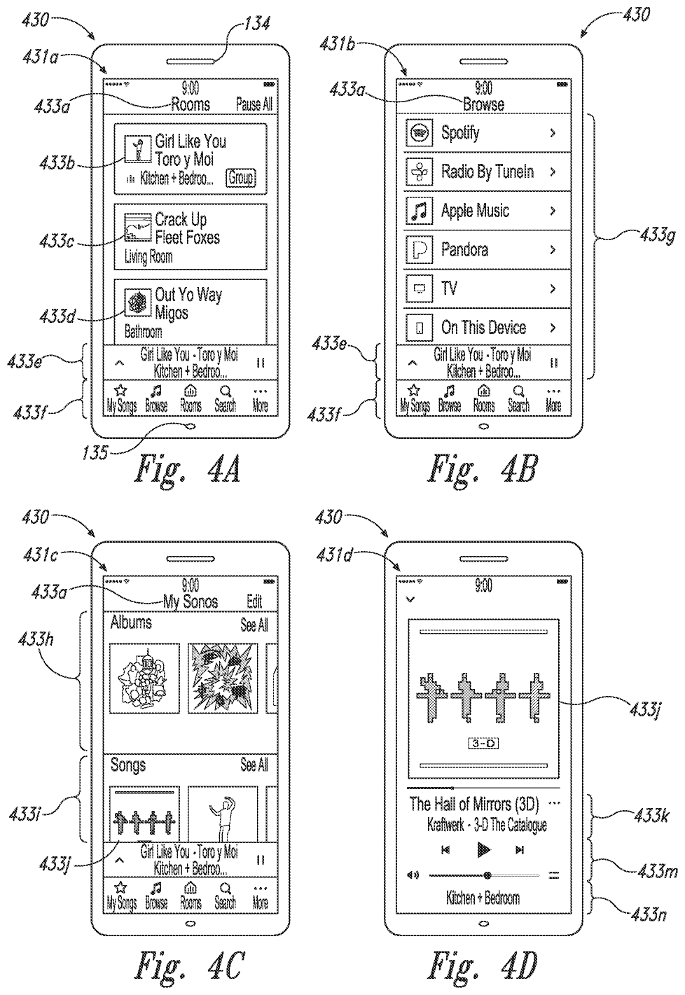

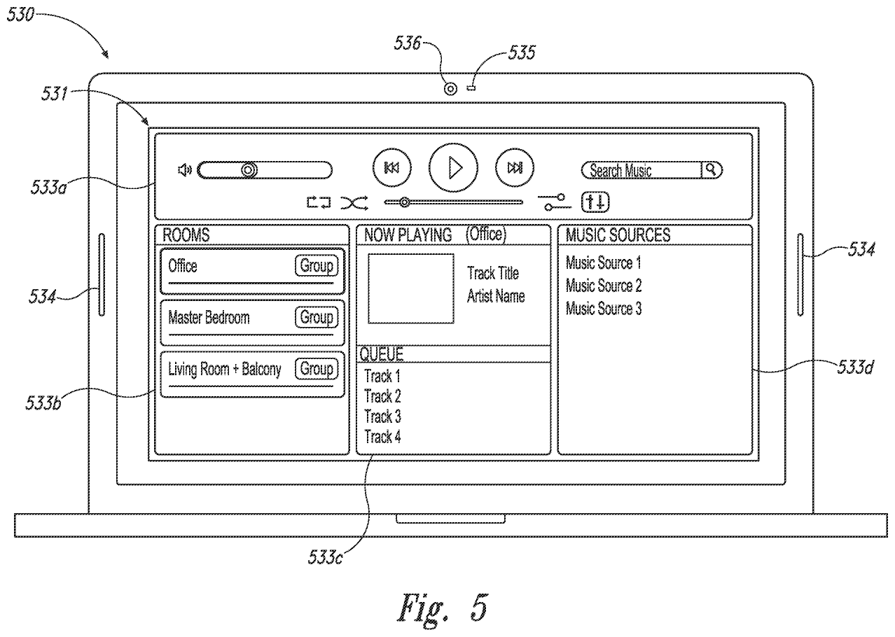

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the playback device 110 may be constructed as a portable playback device, such as an ultra-portable playback device, that comprises an internal power source. FIG. 2D shows an example housing 241 for such a portable playback device. As shown, the housing 241 of the portable playback device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable playback device without the use of conductive contacts. For example, the dock 246 may wirelessly charge the portable playback device via one or more inductive coils integrated into each of the dock 246 and the portable playback device.

In some examples, the playback device 110 may take the form of a wired and/or wireless headphone (e.g., an over-ear headphone, an on-ear headphone, or an in-ear headphone). For instance, FIG. 2E shows an example housing 250 for such an implementation of the playback device 110. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy or power source and weigh less than fifty ounces.

In some examples, the playback device 110 may take the form of an in-ear headphone device. It should be appreciated that the playback device 110 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of playback and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 110 is described with reference to MPS 100, one skilled in the art will recognize that playback devices as described herein can be used in a variety of different environments, including (but not limited to) environments with more and/or fewer elements, without departing from this invention. Likewise, MPS s as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes, or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 3280. In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

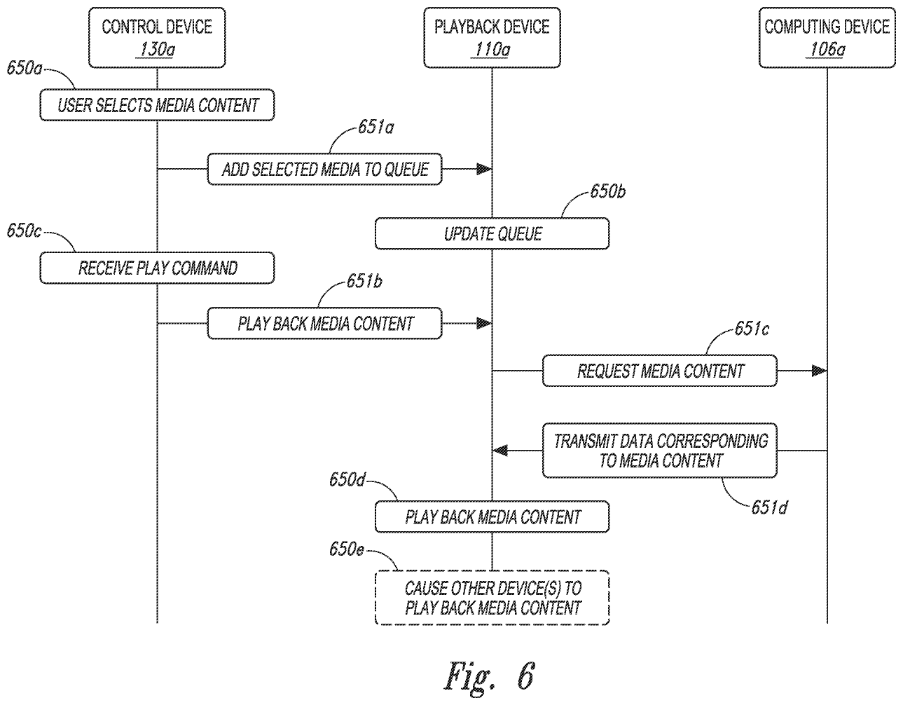

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Example Systems and Methods for Selectively Storing Media Content on Portable Playback Devices

Systems and methods for selectively storing content items, such as digital songs, in local storage systems of one or more playback devices are disclosed. Using the disclosed systems and methods the media playback system can determine when songs should be streamed without being stored in local storage for later playback and when songs should be stored in local storage for later playback. Additionally, the disclosed systems and methods provide a user interface that enables users to identify songs for download to one or more playback devices. A media playback system may comprise one or more playback devices, including at least one playback device (e.g., a portable device) having its own data storage system. In a conventional system each streaming playback device typically receives content for playback and stores or caches the content only temporarily for playback purposes and then discards or overwrites the content. Thus, the streaming content is only stored in the streaming playback devices ephemerally. Streaming content from external devices can lead to disruptions during playback for several reasons, such as loss of network (e.g., WiFi, BLUETOOTH, etc.) connectivity, reduction in download speeds, service outages, etc. The inventors have observed that storing content on the streaming playback device itself can eliminate many of these disruptions, thereby enhancing the user experience. Moreover, playing content from a local storage system can eliminate the need for one or more communication systems of the playback device. If the playback device is operating on battery power, disabling these communication systems can reduce the load on the battery, thereby prolonging the life of the battery and extending the playback time of the playback device.

Playback devices can include storage systems for any number of purposes. In some cases, a playback device includes storage systems for storing firmware that the playback devices uses to operate, storage systems for temporarily storing content being streamed to the playback device, and so on. In some cases, these storage systems are larger than currently necessary for their intended purposes and may be available to store media content for later playback. In some cases, a playback device includes dedicated storage for storing media content for later playback. While the local storage system of a playback device may provide sufficient storage for playing back songs or other media content, the local storage system is not without limits. Accordingly, the disclosed media playback system provides one or more user interfaces that allow one or more users to select which songs are downloaded to one or more playback devices and when. Additionally, the one or more user interfaces allow one or more users to establish conditions under which the songs are automatically downloaded to one or more playback devices. In some examples, the media playback system configures playback devices to automatically download any content item that is added to a playback device's playback queue. Additionally, the media playback system allows users to designate playlists for automatic download, such that whenever a content is added to such a playlist the content item is automatically downloaded to one or more designated playback devices. If any of the designated playback devices is unavailable (e.g., powered off, not connected to a network, in use, etc.) the media playback system can delay the download until the playback device becomes available. Additionally, whenever content is removed from such a playlist the content item can be automatically removed from the one or more designated playback devices. In some cases, rather than removing or deleting a content item from a playback device, the media playback system marks the content item for deletion and then remove the content item when a content item is to be added or when available storage capacity reaches a predetermined threshold, such a predetermined size (e.g., 50 MB, 100 MB, 200 MB, etc.), a predetermined percentage of storage capacity (e.g., 10%, 20%, 30%, etc.), and so on. In this manner, the media playback system reduces the number of unnecessary changes to the underlying storage system, which can shorten the lifetime of the storage system and its underlying storage media. In some cases, the media playback system allows users to enable and disable the automatic download option via, for example, a physical button or switch on the playback device, an option in a controller application, such a mobile application, and so on.

In some cases, rather than automatically downloading songs to a playback device, the media playback system allows users to mark songs for download but then waits for a specific instruction to initiate the download(s). In this way, the user can control the time and manner of download so that, for example, the playback device does not download songs while, for example, operating on battery power, streaming media for playback, connected to a busy or overloaded network, etc. The media playback system may also allow a user to schedule the download for a specific day and time, network conditions, etc. Accordingly, the download can be delayed so that the playback device does not use valuable network bandwidth resources while the network is busy.

After songs are downloaded onto a playback device, the playback device may be configured to stream songs, play songs on the device, or both. In some cases, the media playback system may automatically disable streaming on the playback device in response to certain conditions. For example, if the playback device loses connectivity to a streaming service or the data transfer rate drops below a predetermined threshold, the media playback system can configure the playback device so that it only plays songs stored locally on the playback device. As another example, if a controller device for controlling a playback device, such as a mobile phone connected to the playback device via BLUETOOTH, becomes unavailable (e.g., if it receives a phone call or moves beyond a communication range), the media playback system can configure the playback device so that it only plays songs stored locally on the playback device. Similarly, the media playback system can provide an interface that allows users to configure the device so that it only plays locally stored content, such as a physical button or switch on the playback device, an option in a controller application, and so on. In this manner, a portable playback device can be configured to stream media when an appropriate connection is available and to play stored content when such a connection is not available.

In some examples, in addition to selecting content for download, the user also selects which playback devices should download the selected content. For example, if the user is planning to take just one playback device to an outdoor party, the user may only wish to have the content downloaded to that one playback device. However, if the user is planning to use multiple playback devices at the outdoor party, the user may wish to have content downloaded to one or more of the playback devices. If each of the playback devices has sufficient storage capacity for the selected content, the user may have each of the selected content items downloaded to each of the playback devices. In this manner, if the playback devices are configured for coordinated playback, the playback group coordinator need only send timing information to the other playback devices to coordinate synchronous playback.

For content items that are stored on multiple playback devices, the media playback system may use any number of techniques to assign a playback group coordinator for coordinated playback. For example, the media playback system may select the playback device with the most remaining battery power or the playback device with the longest remaining playback time as the playback group coordinator. Alternatively, the media playback system may randomly select one of the playback devices as the playback group coordinator, select a playback group coordinator based on the physical location of the playback devices, and so on. Thus, responsibility of playback group coordinator can be shared between devices, thereby extending the battery of life of one or more of the playback devices and extending user enjoyment of the playback group coordination.

If one or more of the playback devices cannot accommodate one or more content items (e.g., if a playback device does not have enough storage space for all of the content items), coordinated playback may still be available. In these cases, the media playback system dynamically selects one of the playback devices storing the one or more content items as a playback group coordinator which, in turn, can transmit both content item data and timing information to playback devices that do not store the one or more content items so that each of the playback devices can still play the one or more content items during coordinated playback.

In some cases, a user may wish to take advantage of the coordinated playback system feature of the media playback system by storing different content items on each of the multiple playback devices. During coordinated playback of these content items, the media playback system can assign the playback device storing the content as a playback group coordinator which can, in turn, transmit content item information and timing information to coordinate playback with one or more other playback devices within communication range. Thus, coordinated playback by playback devices is not limited to the storage capacity of any one particular playback device.

Further examples of techniques for implementing synchronous group playback without Wi-Fi access may be found, for example, in U.S. Application No. 63/352,862 filed Jun. 16, 2022 and titled “Techniques for Off-Net Synchrony Group Formation;” U.S. Application No. 63/249,192 filed Sep. 28, 2021, and titled “Synchronous Playback of Media Content by Off-Net Portable Playback Devices;” and U.S. Application No. 63/278,883, filed Nov. 12, 2021 and titled “Synchronous Playback of Media Content by Off-Net Portable Playback Devices.” Each of these applications is incorporated herein by reference in its entirety.

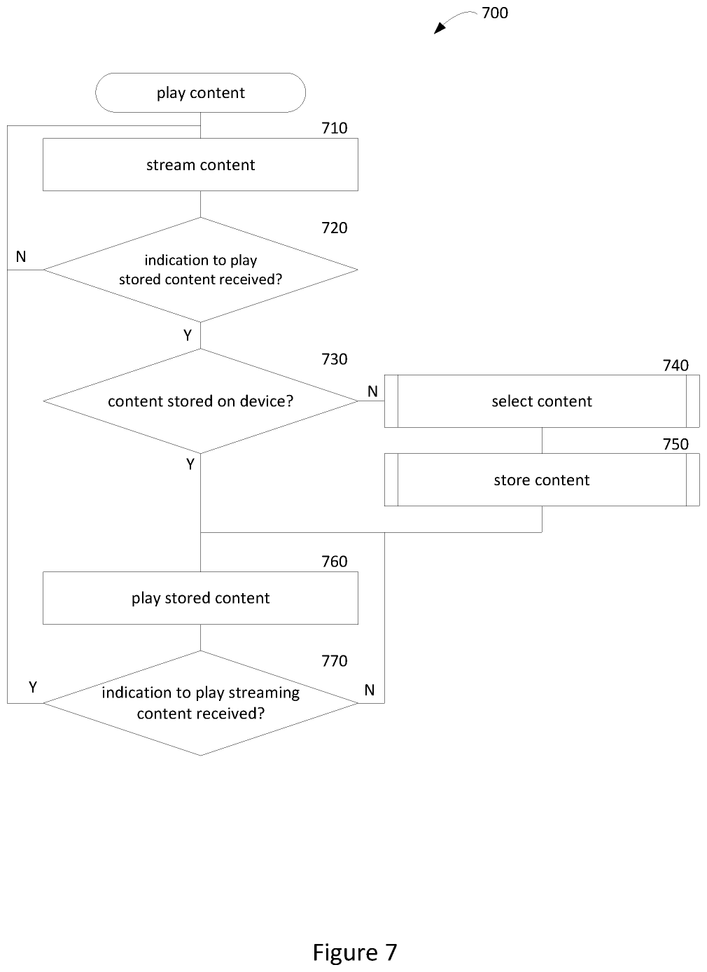

FIGS. 7-10 illustrate example methods in accordance with the present technology. The methods 700, 800, 800, and 1000 can be implemented by any of the devices described herein, or any other suitable devices now known or later developed. Various embodiments of the methods 700, 800, 900, and 1000 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 700, 800, 900, and 1000 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 7-10 may represent circuitry that is wired to perform the specific logical functions in the process.

FIG. 7 illustrates an example method 700 for playing content via one or more playback devices in accordance with some embodiments of the disclosed technology. With reference to FIG. 7, the method 700 begins at block 710, which involves the playback device streaming content from one or more streaming sources, such as a digital streaming service. In decision block 720, if the playback device has received an indication to play stored content, then processing continues at decision block 730, otherwise the playback device loops back to block 710 to continue streaming content. The indication to play stored content may come from any number of sources. For example, the indication may be generated by the playback device itself when it loses a network connection to the source (or intermediate source) for the streaming data or if the quality of the connection drops below a predetermined threshold (e.g., 32 kbps (kilobits per second), 512 kbps, 1 Mbps (megabits per second), 5 Mbps, etc.). As another example, the indication may be generated in response to a user interaction with a user interface associated with the device, such as a user pressing a physical button the device, or a user's interaction with a user interface element (e.g., button, checkbox, menu, etc.) in a graphical user interface provided by, for example, a controller application on the user's phone. In one such embodiment, a playback device may have a number of customizable buttons (physical or virtual) that each correspond to a different playlist or preferred content that, when pressed or otherwise selected, cause the playback device to, if necessary, download the corresponding content and begin playing the stored content. For example, one button may correspond to a “workout playlist” while another button corresponds to a “daily podcast” or “weekly podcast” playlist. As another example, the indication may be generated by the controller application if the device the controller application is running on is no longer available. For example, if the user's phone receives a phone call while streaming content to the playback device, the controller application may send an indication to the playback device to begin playing stored content. In some cases, the media playback system may automatically store any content item that is currently being streamed by the playback device so that the transition to playing stored content is less perceptible. As another example, the indication may be generated by the media playback system based on a scheduled event.

In decision block 730, if content is stored on the playback device, then processing continues at block 760, otherwise processing continues at block 740. In block 740, the playback device invokes a select content component of the media playback system to allow a user to select content items for download. In block 750, the component invokes a store content component to download and store the content on the playback device. In block 760 the playback device plays content stored on the playback device. In decision block 770, if the playback device has received an indication to play streaming content, then processing continues at block 710 to play streaming content, otherwise the playback device loops back to block 760 to continue playing stored content. In some cases, the playback device may allow a content item to finish playing before transitioning to streaming content. In some cases, the playback device may begin streaming a version of the currently playing stored content if, for example, the quality of the streaming version is greater than the quality of the stored content. The indication to play streaming content may come from any number of sources. For example, the indication may be generated by the playback device itself when it re-gains a lost network connection to a source (or intermediate source) of streaming data or if the quality of a connection has improved to above a predetermined threshold (e.g., 32 Kbps, 512 Kbps, 1 Mbps, 5 Mbps, etc.). As another example, the indication may be generated in response to a user interaction with a user interface associated with the device, such as a user pressing a physical button the device, or a user's interaction with a user interface element (e.g., button, checkbox, menu, etc.) in a graphical user interface provided by, for example, a controller application on the user's phone. As another example, the indication may be generated by the controller application if the device the controller application is running on becomes available, such as when a phone call or other interaction on the phone ends. Thus, the disclosed media system enables a playback device to play both streaming content and stored content and to transition between each when appropriate or desired. In this manner, the playback device can dynamically transition between streaming and stored playback, depending on the availability of each. The playback device may play available content (e.g., randomly, on a loop, etc.) based on user preferences until the device runs out of power or is disabled by a user (e.g., turned off).

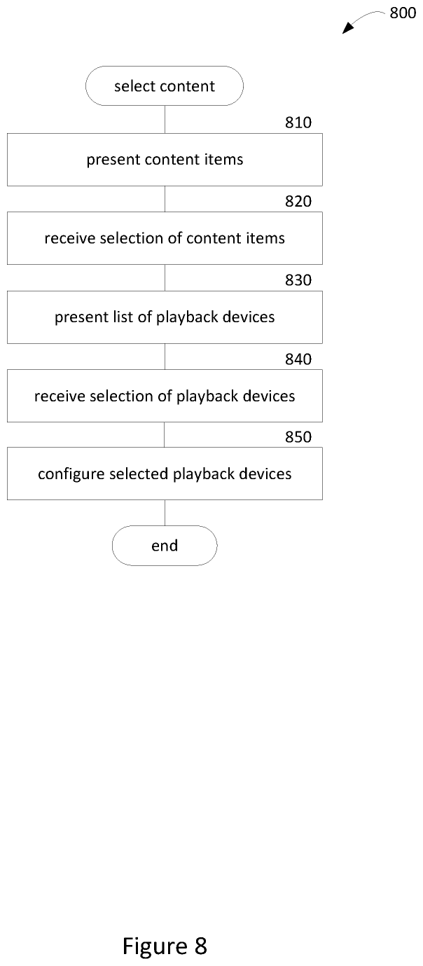

FIG. 8 illustrates an example method 800 for selecting content items to download onto one or more playback devices in accordance with some embodiments of the disclosed technology. With reference to FIG. 8, the method 800 begins at block 810, which involves presenting content items to a user. In some embodiments, the content items are presented via a graphical user interface that allows a user to search for and identify content items for download, such as songs, albums, playlists, movies, etc. The user may select content items for download by, for example, clicking a checkbox adjacent to a displayed content item, right-clicking on the displayed content item and selecting a “Add to Offline Playback Playlist” menu item, and so on. In some cases, the graphical user interface may include, with the display of a particular content item, an indication that the particular content item has already been downloaded to one or more playback devices, such as a familiar name of the playback device (e.g., “Brian's Headphones”), an icon associated with the playback device, etc. In some cases, the graphical user interface may include an indication of the number of available playback devices that have already downloaded the particular content item which, when selected, provides a list of the available playback devices that have already downloaded the particular content item.

When a user selects a content item for download, the user interface may signal the selection by changing the color of the content item in the user interface. For example, content items that have not been selected for download may be displayed using one color (e.g., gray) when they have not been selected for download, another color (e.g., yellow) when they have been selected for download but the download process has not been initiated, another color (e.g., orange) while being downloaded, another color (e.g., green) after the download is complete, and another color (e.g., red) when marked for deletion. In another example, rather than using colors, the media playback system may display different icons in conjunction with the content item to represent its state (e.g., not selected, selected, downloading, downloaded, marked for deletion, etc.). In some cases, the media playback may employ a progress bar or color gradient to reflect the state of the content item.

In block 830, the media playback system identifies and presents a list of playback devices via the graphical user interface. For example, the media playback system may identify playback devices by accessing a device roster or manifest associated with a group of playback devices. As another example, the media playback system may identify playback devices that are in proximity to the media playback system based on a determination that the media playback system and the playback device are communicatively coupled via a common local area network, based on a determination that they are in direct wireless communication (e.g., Bluetooth, NFC, ultra-wideband (UWB), etc.), based on a received signal strength indicator (RSSI), based on an audible chirp emitted via one device and detection via one or more microphones of another device, or any other suitable approach. In block 840, the media playback system receives a selection of one or more playback devices. In block 850, the media playback system configures the selected playback devices to download and store the selected content by, for example, sending an indication of the selected content to the corresponding selected playback device and invoking a store content component of the corresponding selected playback device. In some embodiments, each playback device may need to be further triggered to initiate the download by, for example, waiting until a preset time, waiting until the download has been approved by one or more users, and so on.

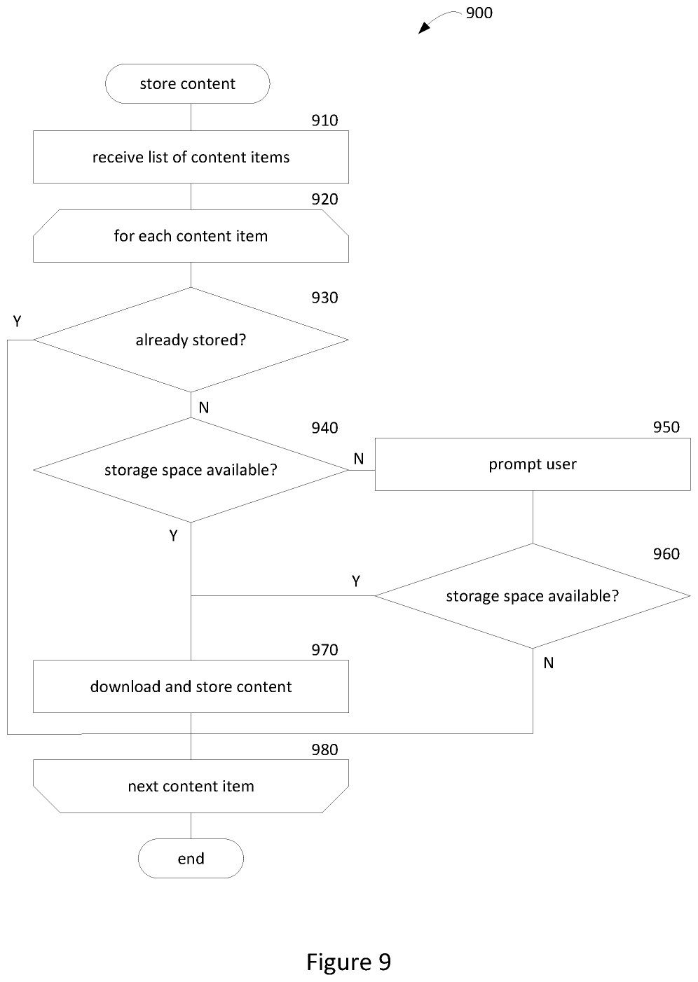

FIG. 9 illustrates an example method 900 for downloading and storing content items on a playback device in accordance with some embodiments of the disclosed technology. With reference to FIG. 9, the method 900 begins at block 910, which involves receiving a list or selection of content items, such as a set of content of items previously selected by a user and sent to the playback device or media playback system. As another example, the user may provide a voice command instructing a playback device to download one or more content items, such as “Hey Sonos Move, download the latest Beyonce album,” “Hey Sonos Roam, download the Billboard Hot 100,” “Hey Sonos Headphones, download my running playlist,” “Hey Sonos Move, download my most frequently played song,” “Hey Sonos Roam, download an hour's worth of contemporary rock songs,” etc. In blocks 920-980, the method loops through each of the content items and attempts to download the content item onto the playback device. In decision block 930, if the currently selected content item is already stored on the playback device, then the method continues at block 980, otherwise the method continues at decision block 940. In decision block 940, if there is storage space available on the playback device (including storage space currently storing content items marked for deletion) for the currently selected content item, then the method continues at block 970, otherwise the method continues at block 950. Alternatively, or additionally, the method 900 may include checking for sufficient remaining battery and/or playback time before downloading and storing a content item. For example, if the playback device only has sufficient battery power to play for one hour, the playback device may only download one hour of content (plus an additional amount (e.g., 5%, 10%, 30%, 50%, 30 minutes, 1 hour) to accommodate for skips, etc.) to reduce unnecessary writing to the local storage system of the playback device. In block 950, the method prompts the user via, for example, a graphical user interface, that there is insufficient capacity for the content item and allows the user to take (or skip) a corrective action (e.g., deleting content stored on the playback device, selecting another device to download the currently selected content item, instructing the media playback system to skip the currently selected content item, and so on). In some embodiments, rather than prompting the user, the media playback system may automatically delete content from the playback device according to any number of deletion priority schemes, such as deleting the most or least frequently played content item(s), deleting the most or least recently downloaded content item(s), deleting the most or least recently accessed content item(s), and do on. In decision block 960, if there is storage space available (e.g., if content has been removed from the playback device to accommodate the currently selected content item, then the method continues at block 970, otherwise the method continues at block 980. In block 970, the method downloads and stores the content onto the playback device. The quality or resolution of the downloaded content may be selected by a user, automatically determined based on the quality of the streaming content, set to default settings (e.g., MP3 192 kbps, WMA 256 kbps, OGG 224 kbps, etc.), etc. In some cases, the method may include selecting a quality level based on the duration of the selected content, such as the highest quality available such that the playback device can store each of the listed content items. In block 980, if there are any content items remaining to be downloaded the method selects the next content item and loops back to block 920 to download the next content item, otherwise the method 900 completes.

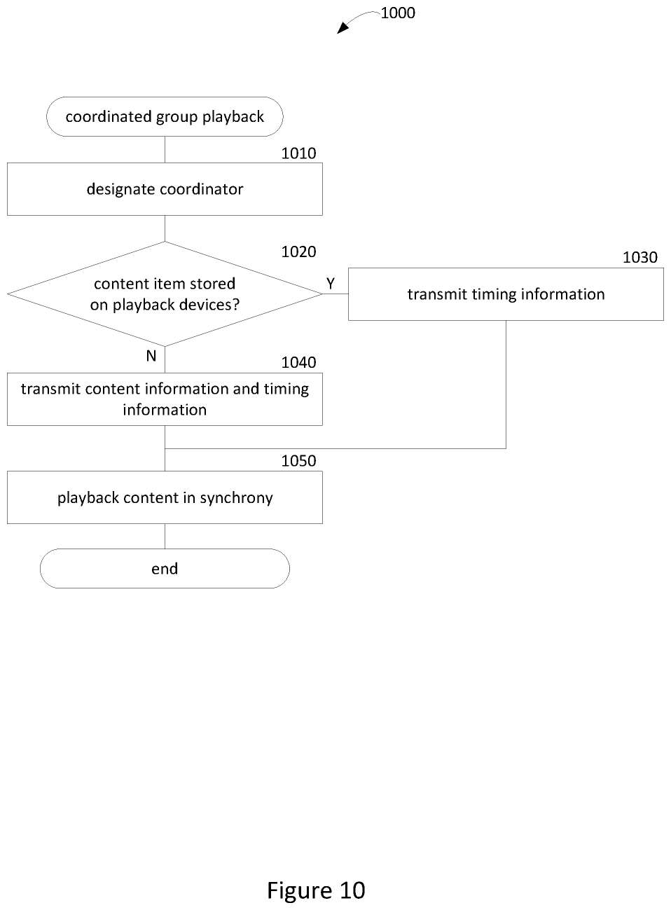

FIG. 10 illustrates an example method 1000 for coordinated playback of a content item among a group of playback devices by a media playback system in accordance with some embodiments of the disclosed technology. In some cases, two or more playback devices of the media playback system within communication range of one another may be configured to form a group (e.g. via button presses on the playback devices or via a controller device in communication with one or more of the playback devices in the group). In block 1010, a group coordinator device is designated from among the group (e.g. by virtue of being the first device chosen, by having the most remaining battery power, or by having stored thereon the pertinent content items, among other possibilities). The group coordinator device will then transmit synchronous playback coordination information to each of the other playback devices in the group. In decision block 1020, if the content item to be played back in synchrony as a group is also stored on the one or more other playback devices in the group, then the group coordinator proceeds to function according to block 1030. If the content item to be played back in synchrony as a group is not also stored on the one or more other playback devices in the group, the group coordinator proceeds to function according to block 1040. In block 1030, the group coordinator transmits only timing information to the one or more other playback devices in the group, such as a current playback position, current playback rate, etc. corresponding to the content being played back that is also stored on the one or more other playback devices in group. In block 1040, the group coordinator transmits both content information (e.g. audio data for the content item) as well as the corresponding timing information to the one or more other playback devices in the group. In block 1050, the group coordinator plays back content in synchrony via the one or more other playback devices in the group according to the transmitted timing and content information, or only timing information. In some cases, the group may include one or more playback devices that store the content item to be played back in synchrony as a group and one or more playback devices that do not store the content item to be played back in synchrony as a group.

In the illustrated examples described above, the devices may be shown as audio and/or video playback devices. In some examples, however, one or more of the devices may comprise other types of devices including smartphones, tablets, video display devices (e.g., televisions, projectors), lanterns or flashlights, internet of things (IoT) devices such as sensors, cameras, microphones, thermostats, light sources, smart doorbells, etc.

### V. Conclusion

The above discussions relating to wireless power transfer devices, playback devices, controller devices, playback zone configurations, and media/audio content sources provide only some examples of operating environments within which functions and methods described below may be implemented. Other operating environments and configurations of wireless power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A media playback system comprising: a first playback device having a first content store; and one or more computer-readable media having instructions stored thereon that, when executed by one or more processors, cause the media playback system to perform operations comprising: configuring the first playback device to stream content items received via a network connection without storing the streamed content in the first content store, after receiving an indication to store content, identifying one or more content items to download onto the first playback device, retrieving the identified one or more content items to download onto the first playback device, storing the retrieved one or more content items in the first content store of the first playback device, and configuring the first playback device to play content items from the first content store of the first playback device.

Example 2: The media playback system of any one of the Examples herein, the operations further comprising: after receiving a request to play a first content item, identifying, from among a plurality of synchronized playback devices, one or more playback devices storing the first content item, and selecting, from among the identified one or more playback devices storing the first content item, a playback coordinator for coordinating playback of the first content item.

Example 3: The media playback system of any one of the Examples herein, wherein the playback coordinator is configured to: during coordinated playback of the first content item, send timing information to a first identified playback device storing the first content item without sending audio content to the first identified playback device, and send timing information and audio content to at least one playback device that does not store the first content item.

Example 4: The media playback system of any one of the Examples herein, the operations further comprising: after determining that a first content item has been added to a queue associated with the first playback device, automatically downloading the first content item to the first playback device.

Example 5: The media playback system of any one of the Examples herein, wherein identifying one or more content items to download onto the playback device comprises: accessing a playlist associated with the playback device, the playlist identifying one or more content items; and identifying, from the accessed playlist, content items marked for download

Example 6: The media playback system of any one of the Examples herein, the operations further comprising: providing, for display, a user interface comprising, for each of the one or more content items identified by the accessed, an indication of whether the content item is stored in the first content store of the first playback device.

Example 7: The media playback system of any one of the Examples herein, wherein the streamed content items are played at a first resolution and wherein the content items stored in the first content store are played at a second resolution different from the first resolution.

Example 8: The media playback system of any one of the Examples herein, the operations further comprising: while the first playback device has a WiFi connection, configuring the first playback device to stream content items received via the WiFi connection; and after determining that the WiFi connection has been lost, configuring the first playback device to stream content items from the first content store of the first playback device.

Example 9: The media playback system of any one of the Examples herein, the operations further comprising: determining a current battery level for the first playback device, wherein the identifying of the one or more content items to download onto the first playback device is based on the determined current battery level.

Example 10: The media playback system of any one of the Examples herein, the operations further comprising: while the first playback device is playing a first content item from the first content store, receiving, from a controller device, a control command to modify playback of the first content item by the first playback device.

Example 11: The media playback system of any one of the Examples herein, the operations further comprising: while the first playback device is streaming content via a WiFi connection, receiving one or more control instructions via the WiFi connection; and while the first playback device is playing content stored in the first content store, receiving one or more control instructions via a second connection other than the WiFi connection.

Example 12: A method comprising: configuring a first playback device, having a first content store, to stream content items received via a network connection without storing the streamed content in the first content store, after receiving an indication to store content, identifying one or more content items to download onto the first playback device, retrieving the identified one or more content items to download onto the first playback device, storing the retrieved one or more content items in the first content store of the first playback device, and configuring the first playback device to play content items from the first content store of the first playback device.

Example 13: The method of any one of the Examples herein, further comprising: after receiving a request to play a first content item, identifying, from among a plurality of synchronized playback devices, one or more playback devices storing the first content item, and selecting, from among the identified one or more playback devices storing the first content item, a playback coordinator for coordinating playback of the first content item.

Example 14: The method of any one of the Examples herein, wherein the playback coordinator is configured to: during coordinated playback of the first content item, send timing information to a first identified playback device storing the first content item without sending audio content to the first identified playback device, and send timing information and audio content to at least one playback device that does not store the first content item.

Example 15: The method of any one of the Examples herein, further comprising: after determining that a first content item has been added to a queue associated with the first playback device, automatically downloading the first content item to the first playback device.

Example 16: The method of any one of the Examples herein, wherein identifying one or more content items to download onto the playback device comprises: accessing a playlist associated with the playback device, the playlist identifying one or more content items; and identifying, from the accessed playlist, content items marked for download.

Example 17: The method of any one of the Examples herein, the operations further comprising: providing, for display, a user interface comprising, for each of the one or more content items identified by the accessed, an indication of whether the content item is stored in the first content store of the first playback device.

Example 18: The method of any one of the Examples herein, wherein the streamed content items are played at a first resolution and wherein the content items stored in the first content store are played at a second resolution different from the first resolution.

Example 19: The method of any one of the Examples herein, further comprising: while the first playback device has a WiFi connection, configuring the first playback device to stream content items received via the WiFi connection; and after determining that the WiFi connection has been lost, configuring the first playback device to stream content items from the first content store of the first playback device.

Example 20: The method of any one of the Examples herein, further comprising: determining a current battery level for the first playback device, wherein the identifying of the one or more content items to download onto the first playback device is based on the determined current battery level.

Example 21: The method of any one of the Examples herein, further comprising: while the first playback device is playing a first content item from the first content store, receiving, from a controller device, a control command to modify playback of the first content item by the first playback device.

Example 22: The method of any one of the Examples herein, further comprising: while the first playback device is streaming content via a WiFi connection, receiving one or more control instructions via the WiFi connection; and while the first playback device is playing content stored in the first content store, receiving one or more control instructions via a second connection other than the WiFi connection.

Example 23: One or more tangible, non-transitory computer-readable media storing instructions that, when executed by one or more processors of a media playback system, cause the media playback system to perform operations comprising: configuring a first playback device, having a first content store, to stream content items received via a network connection without storing the streamed content in the first content store, after receiving an indication to store content, identifying one or more content items to download onto the first playback device, retrieving the identified one or more content items to download onto the first playback device, storing the retrieved one or more content items in the first content store of the first playback device, and configuring the first playback device to play content items from the first content store of the first playback device.

Example 24: The one or more tangible, non-transitory computer-readable media of any one of the Examples herein, the operations further comprising: after receiving a request to play a first content item, identifying, from among a plurality of synchronized playback devices, one or more playback devices storing the first content item, and selecting, from among the identified one or more playback devices storing the first content item, a playback coordinator for coordinating playback of the first content item.

Example 25: The one or more tangible, non-transitory computer-readable media of any one of the Examples herein, wherein the playback coordinator is configured to: during coordinated playback of the first content item, send timing information to a first identified playback device storing the first content item without sending audio content to the first identified playback device, and send timing information and audio content to at least one playback device that does not store the first content item.

Example 26: The one or more tangible, non-transitory computer-readable media of any one of the Examples herein, the operations further comprising: after determining that a first content item has been added to a queue associated with the first playback device, automatically downloading the first content item to the first playback device.

Example 27: The one or more tangible, non-transitory computer-readable media of any one of the Examples herein, wherein identifying one or more content items to download onto the playback device comprises: accessing a playlist associated with the playback device, the playlist identifying one or more content items; and identifying, from the accessed playlist, content items marked for download.

Example 28: The one or more tangible, non-transitory computer-readable media of any one of the Examples herein, the operations further comprising: providing, for display, a user interface comprising, for each of the one or more content items identified by the accessed, an indication of whether the content item is stored in the first content store of the first playback device.

Example 29: The one or more tangible, non-transitory computer-readable media of any one of the Examples herein, wherein the streamed content items are played at a first resolution and wherein the content items stored in the first content store are played at a second resolution different from the first resolution.

Example 30: The one or more tangible, non-transitory computer-readable media of any one of the Examples herein, the operations further comprising: while the first playback device has a WiFi connection, configuring the first playback device to stream content items received via the WiFi connection; and after determining that the WiFi connection has been lost, configuring the first playback device to stream content items from the first content store of the first playback device.

Example 31: The one or more tangible, non-transitory computer-readable media of any one of the Examples herein, the operations further comprising: determining a current battery level for the first playback device, wherein the identifying of the one or more content items to download onto the first playback device is based on the determined current battery level.

Example 32: The one or more tangible, non-transitory computer-readable media of any one of the Examples herein, the operations further comprising: while the first playback device is playing a first content item from the first content store, receiving, from a controller device, a control command to modify playback of the first content item by the first playback device.

Example 33: The one or more tangible, non-transitory computer-readable media of any one of the Examples herein, the operations further comprising: while the first playback device is streaming content via a WiFi connection, receiving one or more control instructions via the WiFi connection; and while the first playback device is playing content stored in the first content store, receiving one or more control instructions via a second connection other than the WiFi connection.

1. A media playback system comprising:
a first playback device having a first content store; and
one or more computer-readable media having instructions stored thereon that, when executed by one or more processors, cause the media playback system to perform operations comprising:
configuring the first playback device to stream content items received via a network connection without storing the streamed content items in the first content store,
after receiving an indication to store content,
identifying one or more content items to download onto the first playback device,
retrieving the identified one or more content items to download onto the first playback device,
storing the retrieved one or more content items in the first content store of the first playback device, and
configuring the first playback device to play content items from the first content store of the first playback device.

2. The media playback system of claim 1, the operations further comprising:
after receiving a request to play a first content item,
identifying, from among a plurality of synchronized playback devices, one or more playback devices storing the first content item, and
selecting, from among the identified one or more playback devices storing the first content item, a playback coordinator for coordinating playback of the first content item.

3. The media playback system of claim 2, wherein the playback coordinator is configured to:
during coordinated playback of the first content item,
send timing information to a first identified playback device storing the first content item without sending audio content to the first identified playback device, and
send timing information and audio content to at least one playback device that does not store the first content item.

4. The media playback system of claim 1, the operations further comprising:
after determining that a first content item has been added to a queue associated with the first playback device, automatically downloading the first content item to the first playback device.

5. The media playback system of claim 1, wherein identifying one or more content items to download onto the first playback device comprises:
accessing a playlist associated with the first playback device, the playlist identifying one or more content items; and
identifying, from the accessed playlist, content items marked for download.

6. The media playback system of claim 5, the operations further comprising:
providing, for display, a user interface comprising, for each of the one or more content items identified by the accessed playlist, an indication of whether the content item is stored in the first content store of the first playback device.

7. The media playback system of claim 1, wherein the streamed content items are played at a first resolution and wherein the content items stored in the first content store are played at a second resolution different from the first resolution.

8. The media playback system of claim 1, the operations further comprising:
while the first playback device has a WiFi connection, configuring the first playback device to stream content items received via the WiFi connection; and
after determining that the WiFi connection has been lost, configuring the first playback device to stream content items from the first content store of the first playback device.

9. The media playback system of claim 1, the operations further comprising:
determining a current battery level for the first playback device, wherein the identifying of the one or more content items to download onto the first playback device is based on the determined current battery level.

10. The media playback system of claim 1, the operations further comprising:
while the first playback device is playing a first content item from the first content store, receiving, from a controller device, a control command to modify playback of the first content item by the first playback device.

11. The media playback system of claim 1, the operations further comprising:
while the first playback device is streaming content via a WiFi connection, receiving one or more control instructions via the WiFi connection; and
while the first playback device is playing content stored in the first content store, receiving one or more control instructions via a second connection other than the WiFi connection.

12. A method comprising:
configuring a first playback device, having a first content store, to stream content items received via a network connection without storing the streamed content items in the first content store,
after receiving an indication to store content,
identifying one or more content items to download onto the first playback device,
retrieving the identified one or more content items to download onto the first playback device,
storing the retrieved one or more content items in the first content store of the first playback device, and
configuring the first playback device to play content items from the first content store of the first playback device.

13. The method of claim 12, further comprising:
after receiving a request to play a first content item,
identifying, from among a plurality of synchronized playback devices, one or more playback devices storing the first content item, and
selecting, from among the identified one or more playback devices storing the first content item, a playback coordinator for coordinating playback of the first content item.

14. The method of claim 13, wherein the playback coordinator is configured to:
during coordinated playback of the first content item,
send timing information to a first identified playback device storing the first content item without sending audio content to the first identified playback device, and
send timing information and audio content to at least one playback device that does not store the first content item.

15. The method of claim 12, further comprising:
after determining that a first content item has been added to a queue associated with the first playback device, automatically downloading the first content item to the first playback device.

16. One or more tangible, non-transitory computer-readable media storing instructions that, when executed by one or more processors of a media playback system, cause the media playback system to perform operations comprising:
configuring a first playback device, having a first content store, to stream content items received via a network connection without storing the streamed content items in the first content store,
after receiving an indication to store content,
identifying one or more content items to download onto the first playback device,
retrieving the identified one or more content items to download onto the first playback device,
storing the retrieved one or more content items in the first content store of the first playback device, and
configuring the first playback device to play content items from the first content store of the first playback device.

17. The one or more tangible, non-transitory computer-readable media of claim 16, the operations further comprising:
after receiving a request to play a first content item,
identifying, from among a plurality of synchronized playback devices, one or more playback devices storing the first content item, and
selecting, from among the identified one or more playback devices storing the first content item, a playback coordinator for coordinating playback of the first content item.

18. The one or more tangible, non-transitory computer-readable media of claim 17, wherein the playback coordinator is configured to:
during coordinated playback of the first content item,
send timing information to a first identified playback device storing the first content item without sending audio content to the first identified playback device, and
send timing information and audio content to at least one playback device that does not store the first content item.

19. The one or more tangible, non-transitory computer-readable media of claim 16, the operations further comprising:
after determining that a first content item has been added to a queue associated with the first playback device, automatically downloading the first content item to the first playback device.

20. The one or more tangible, non-transitory computer-readable media of claim 16, wherein identifying one or more content items to download onto the first playback device comprises:
accessing a playlist associated with the first playback device, the playlist identifying one or more content items; and
identifying, from the accessed playlist, content items marked for download.
